(19) United States
(12) Patent Application Publication
(10) Pub. No.: US 2017/0154476 A1
(43) Pub. Date: Jun. 1, 2017

(54) INFORMATION BACKING UP METHOD AND SYSTEM

(71) Applicant: Metal Industries Research & Development Centre, Kaohsiung (TW)

(72) Inventors: Chih-Ming Chang, Kaohsiung City (TW); Kuang-Shine Yang, Tainan City (TW); Ho-Chung Fu, Kaohsiung City (TW); Ying-Cherng Lu, Kaohsiung City (TW); Chih-Ming Chiou, Pingtung County (TW)

(21) Appl. No.: 14/953,433

(22) Filed: Nov. 30, 2015

(51) Int. Cl. G07C 5/00; H04L 29/08; H04L 29/06; H04W 76/02; G07C 5/08; H04W 4/00

(52) U.S. Cl. CPC G07C 5/008; G07C 5/0808; H04W 4/005; H04L 65/1069; H04W 76/02; H04L 67/1095; H04L 67/42

(57) ABSTRACT

An information backing up method and system are provided. The information backing up system at least includes a moving vehicle and a server. The moving vehicle obtains its external information and internal information, establishes a transmitting connection with the server through a machine-to-machine (M2M) protocol, and transmits the external information and the internal information to the server through the transmitting connection. In addition, the information backing up system may further include a network gateway device, so that the moving vehicle can perform an information backup procedure through the network gateway device.

### BACKGROUND OF THE INVENTION

Field of the Invention

The invention relates to a backup technique, particularly to an information backing up method and an information backing up system.

Description of Related Art

“Black box” also known as a flight recorder, is one of electronic recording devices used exclusively on airplanes. The black box includes a flight data recorder and a cockpit voice recorder, and is connected with sensors disposed on each mechanical part and electronic instrument on an airplane. The black box records relevant technical parameters and sounds in the cockpit that are generated during the half hour before the airplane ceases operating or crashes, and plays the recorded parameters if needed for a flight experiment or accident analysis. The black box is extremely superior in fire resistance, pressure resistance, impact and vibration resistance, sea water (or kerosene) immersion resistance, and magnetic interference resistance, etc. The records and data stored in the black box remain undamaged even if the airplane is completely destroyed. For most of the aircraft accidents that have happened around the world, the causes were identified through the black boxes.

Currently, two types of black boxes are provided on most passenger and military aircrafts. One is called a flight data recorder (FDR), which is used for recording various data (e.g., flight time, flight speed, flight altitude, tilt degree of an aircraft rudder, engine rotation speed, engine temperature, etc.; there are more than 30 kinds of data in total) during a flight, and may store up to 25 hours of data. Before takeoff, the pilot switches on the black box so as to record and store the above-mentioned various data in the black box during the flight. Once an aircraft accident has occurred, the flight parameters during the entire accident can be obtained from the black box, and thereby the cause of the accident can be identified. The other type of black box is called a cockpit voice recorder (CVR), which acts as a tape recorder, recording speech sounds between pilots or of passengers, hijackers and flight attendants by microphones disposed in the cockpit and cabins. The CVR has a recording time of 30 minutes. When 30 minutes have passed, the CVR resets and starts a new recording session. Therefore, the second type of black box records and stores important information of activity on the airplane during the last 30 minutes prior to an aircraft accident.

It is clear from the above that when an aircraft accident occurs, it is necessary to find the black box in order to obtain the various information recorded therein. In other words, if the black box fails to be found, the cause of the aircraft accident cannot be identified.

### SUMMARY OF THE INVENTION

The invention provides an information backing up method and an information backing up system, by which relevant information of a vehicle can be transmitted to a server in real time based on a machine-to-machine (M2M) protocol, thereby eliminating the existing fear that the cause of an aircraft incident cannot be identified in cases the black box is lost.

The invention proposes an information backing up method applicable to a moving vehicle and a server, wherein the method includes the following steps. External information and internal information of the moving vehicle is obtained. A transmitting connection is established between the moving vehicle and the server through a machine-to-machine (M2M) protocol. The external information and the internal information are transmitted to the server through the transmitting connection.

In an embodiment of the invention, the step of establishing the transmitting connection between the moving vehicle and the server through the M2M protocol includes the following steps. The server is connected to via a mobile network. An M2M handshaking procedure is performed with the server based on the M2M protocol through the mobile network.

In an embodiment of the invention, the external information includes an external image, an audio signal and external transmission information, and the step of obtaining the external information and the internal information of the moving vehicle includes the following steps. The external image is obtained through an image capturing apparatus. The audio signal is recorded through a recording apparatus. The external transmission information is received from a wearable apparatus.

In an embodiment of the invention, the internal information includes motion information, position information and mechanical control information, and the step of obtaining the external information and the internal information of the moving vehicle includes the following steps. The motion information is obtained through a transducer. The position information of the moving vehicle is obtained through a positioning system. The mechanical control information of a plurality of machine elements in the moving vehicle is obtained.

In an embodiment of the invention, after the external information and the internal information are transmitted to the server through the transmitting connection, the following step is further included. The external information and the internal information are analyzed through the server, so that a dispatching management operation, a mobile management operation, and a resource management operation are performed.

The invention proposes an information backing up system that includes a moving vehicle and a server. The moving vehicle obtains its external information and internal information, establishes a transmitting connection with the server through a machine-to-machine (M2M) protocol, and transmits the external information and the internal information to the server through the transmitting connection.

In an embodiment of the invention, the moving vehicle connects to the server via a mobile network, and performs an M2M handshaking procedure with the server based on the M2M protocol through the mobile network.

In an embodiment of the invention, the external information includes an external image, an audio signal and external transmission information. The moving vehicle obtains the external image through an image capturing apparatus, records the audio signal through a recording apparatus, and receives the external transmission information from a wearable apparatus.

In an embodiment of the invention, the internal information includes motion information, position information and mechanical control information. The moving vehicle obtains the motion information through a transducer, obtains the position information of the moving vehicle through a positioning system, and obtains the mechanical control information of a machine element in the moving vehicle.

In an embodiment of the invention, the server analyzes the external information and the internal information, so as to perform a dispatching management operation, a mobile management operation, and a resource management operation.

The invention proposes another information backing up system that includes a server, a network gateway device and a moving vehicle. The moving vehicle obtains its external information and internal information, establishes a transmitting connection with the server via the network gateway device through a machine-to-machine (M2M) protocol, and transmits the external information and the internal information to the server through the transmitting connection.

Based on the above, by the information backing up method and system proposed by the embodiments of the invention, the various information collected by the moving vehicle is backed up onto the server, so that the server can manage and control the moving vehicle based on the backed-up information. Accordingly, when an accident has happened to the moving vehicle, a rescue operation can be performed immediately based on the uploaded information. In addition, the embodiments of the invention enable a control center to easily manage the moving vehicle.

To make the above features and advantages of the invention more comprehensible, embodiments accompanied with drawings are described in detail as follows.

### BRIEF DESCRIPTION OF THE DRAWINGS

FIG. 1 is a schematic block diagram illustrating an information backing up system according to an embodiment of the invention.

FIG. 2 is a block diagram illustrating elements of a moving vehicle according to an embodiment of the invention.

FIG. 3 illustrates a scheme of transmitting internal information of the moving vehicle according to an embodiment of the invention.

FIG. 4 is a stack diagram illustrating a communications protocol according to an embodiment of the invention.

FIG. 5 illustrates a relationship between the physical layer and the media access control layer in FIG. 4 according to an embodiment of the invention.

FIG. 6 is a flow chart illustrating an information backing up method according to an embodiment of the invention.

FIG. 7 is a schematic block diagram illustrating an information backing up system according to another embodiment of the invention.

FIG. 8 illustrates an example of a process of backing up information according to an embodiment of the invention.

### DETAILED DESCRIPTION OF DISCLOSED EMBODIMENTS

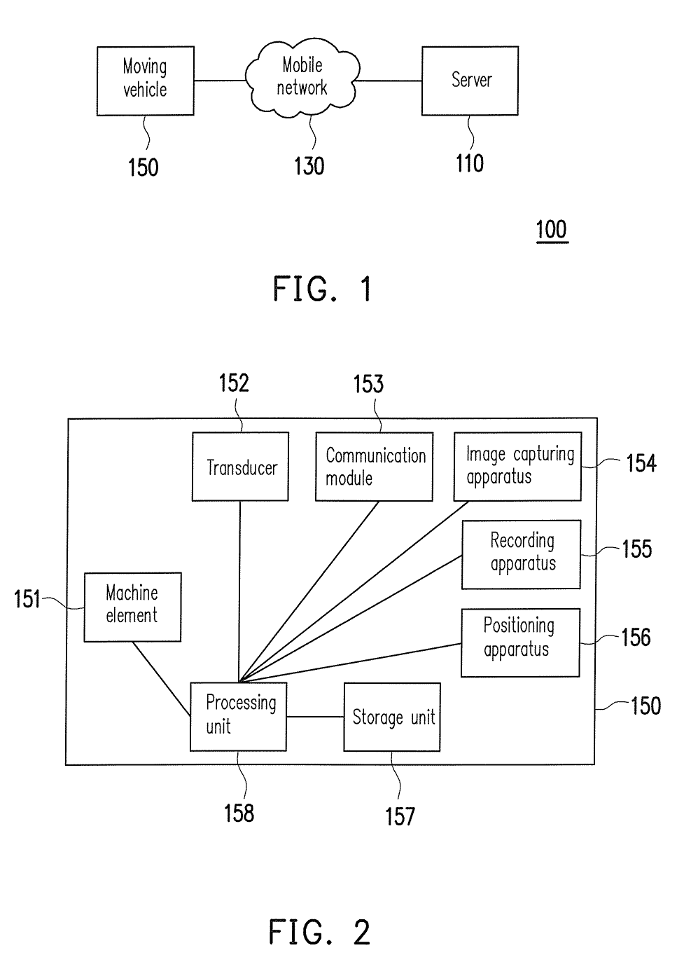

FIG. 1 is a schematic block diagram illustrating an information backing up system according to an embodiment of the invention. Referring to FIG. 1, an information backing up system 100 includes a server 110 and a moving vehicle 150. It is to be noted that, in actual application, the information backing up system 100 may include more than one server 110 and more than one moving vehicle 150.

The server 110 is, e.g., a computing apparatus, such as a machine-to-machine data collection center having computing capability, an analog/digital server, a file server, a database server, an application program server, a cloud server, a work station or a personal computer.

The moving vehicle 150 is a movable transportation means of arbitrary kind, such as a car, an aircraft, or a ship, etc. FIG. 2 is a block diagram illustrating elements of the moving vehicle 150 according to an embodiment of the invention. Referring to FIG. 2, the moving vehicle 150 includes, but not limited to, at least one kind of machine element 151, at least one kind of transducer 152, a communication module 153, an image capturing apparatus 154, a recording apparatus 155, a positioning apparatus 156, a storage unit 157 and a processing unit 158.

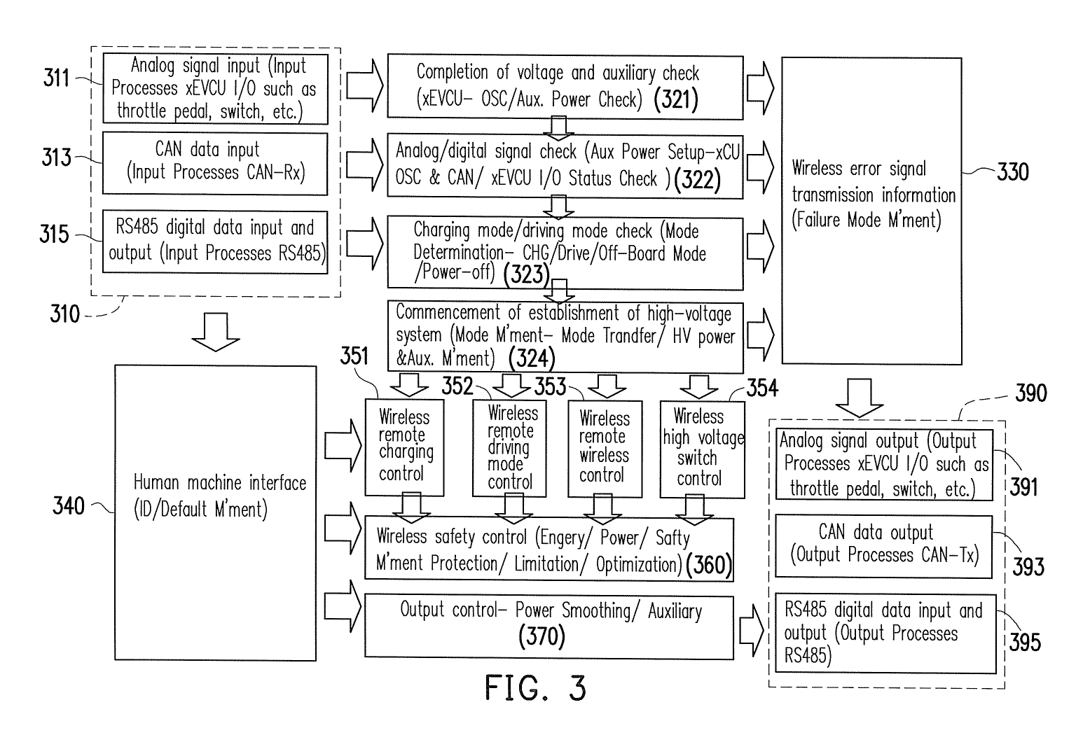

The machine element 151 is, e.g., an element of arbitrary kind in a power system, a transmission system, an air-conditioning system, an anti-theft device, a cleaning element, or an audio device. For example, FIG. 3 illustrates a scheme of transmitting internal information of the moving vehicle 150 according to an embodiment of the invention. Referring to FIG. 3, in an input procedure 310, an analog signal input 311 (throttle pedal, switch, etc.), a controller area network (CAN) data input 313, and an RS485 digital data input and output 315 are obtained. Next, based on the input information of the input procedure 310, a voltage and auxiliary check 321, an analog/digital signal check 322, a mode determination 323 (e.g., check on modes of charging (CHG), driving, high-voltage (HV) power supply, etc.), and a mode activation 324 (e.g., establishment of establishment of a high-voltage system) are carried out. If an error occurs during a check process, wireless error signal transmission information 330 is generated. Based on the selection of the mode determination 323, wireless remote charging control 351, wireless remote driving mode control 352, wireless remote wireless control 353 or wireless high voltage switch control 354 is performed. The input information of the input procedure 310 is also inputted to a human machine interface (HMI) 340 so that an operator of the moving vehicle 150 can easily look for information and perform operations. Next, the moving vehicle 150 performs a wireless safety control 360 (e.g., energy, power supply, safety protection, limitation, optimization, etc.) and performs a control information output 370 (e.g., output control, remote wireless vehicle driving performance adjustment, etc.). In an output procedure 390, information of error signals, mode control, safety control and so on is outputted through an analog signal output 391 (throttle pedal, switch, etc.), a CAN data output 393, and an RS485 digital data input and output 395. In the present embodiment, the various information, data and signals generated by the machine element 151 are collectively referred to as mechanical control information.

The transducer 152 is, e.g., a transducer of arbitrary kind that is used in the moving vehicle 150, such as an accelerometer, a gyro sensor, an electronic compass, a G-sensor, or a temperature sensor, etc. In an embodiment, the transducer 152 obtains motion information (e.g., flying posture, traveling speed, traveling direction, etc.) of the moving vehicle 150.

The communication module 153 is, e.g., a cable network module such as an Ethernet module, a wireless communication module such as a Bluetooth, WiFi, 2G, 3G, or 4G communication module, a controller area network (CAN) or a CAN bus. Through the communication module 153, the moving vehicle 150 connects to the server 110 via a mobile network 130 (e.g., 2G, 3G or 4G network).

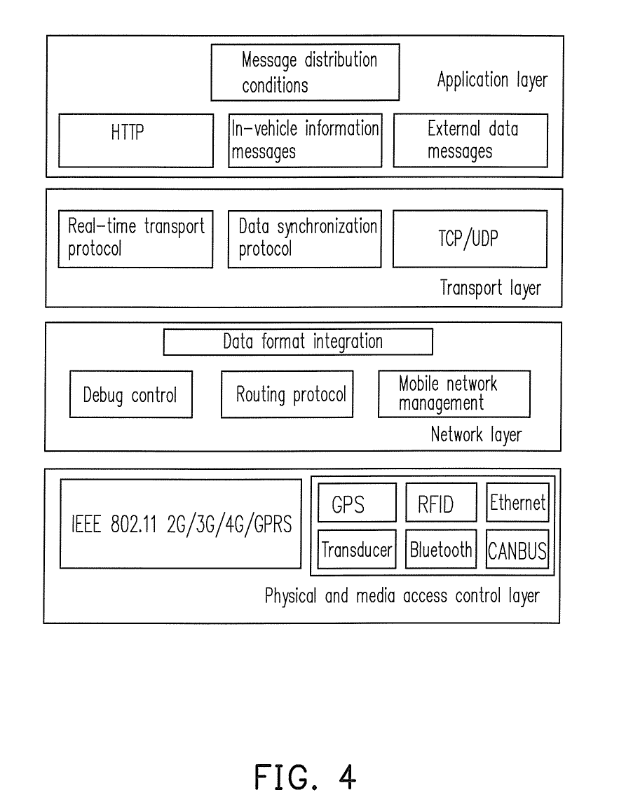

For example, FIG. 4 is a stack diagram illustrating a communications protocol according to an embodiment of the invention. Referring to FIG. 4, in physical and media access control (MAC) layers, depending on the communication module 153, the transducer 152 and the positioning apparatus 156 installed in the moving vehicle 150, the following standards may exist: IEEE 802.11, 2G/3G/4G/General Packet Radio Service (GPRS), radio-frequency identification (RFID), Ethernet, transducer, Bluetooth and/or CAN bus. A network layer includes debug control, routing protocol, mobile network management and data format integration. A transport layer includes the Real-time Transport Protocol (RTP), data synchronization protocol, and the Transmission Control Protocol (TCP) or the User Datagram Protocol (UDP). Depending on different needs, an application layer may include the Hypertext Transfer Protocol (HTTP), in-vehicle information messages, external data messages, and message distribution conditions.

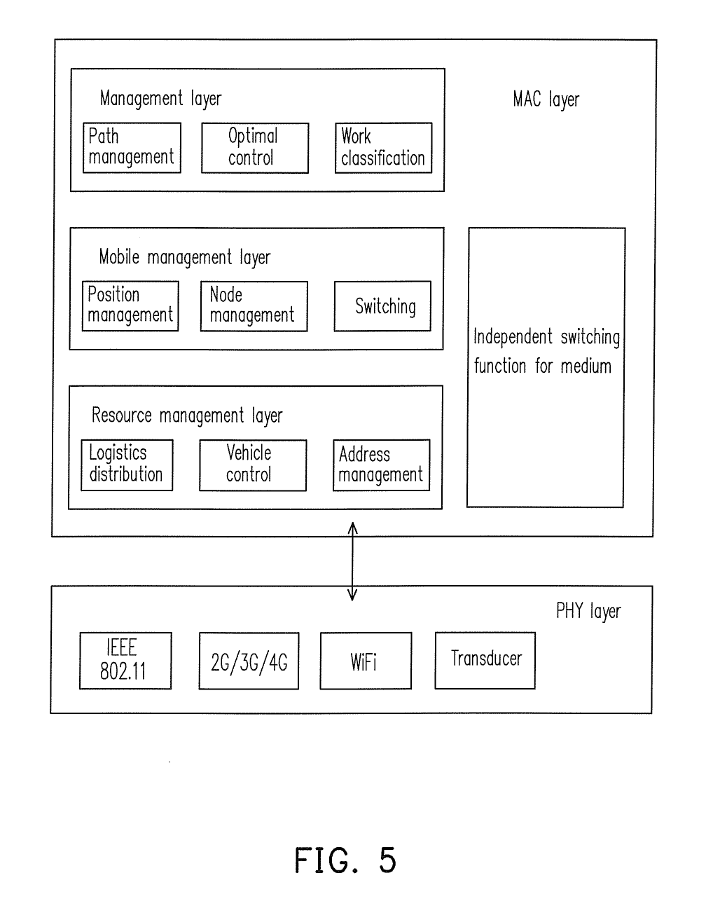

In addition, FIG. 5 illustrates a relationship between the physical layer and the media access control layer in FIG. 4 according to an embodiment of the invention. Referring to FIG. 5, the physical (PHY) layer can be understood by the description of the physical and media access control layers in FIG. 4, and details thereof are thus omitted herein. Depending on different needs, the media access control (MAC) layer may include an independent switching function for medium, a resource management layer (e.g., logistics distribution, vehicle control, address management, etc.), a mobile management layer (e.g., position management, node management, switching, etc.) and a resource management layer (e.g., path management, optimal control, work classification, etc.).

The image capturing apparatus 154 is, e.g., a camera or a video camera, and is configured to capture at least one external image outside the moving vehicle 150. The recording apparatus 155 is, e.g., an apparatus having a microphone for sound recording, and is configured to record an audio signal inside the moving vehicle 150. The positioning apparatus 156 is, a device based on a satellite navigation system such as the Global Positioning System (GPS), the Assisted Global Positioning System (AGPS), or the Galileo Positioning System or the GLObal NAvigation Satellite System (GLONASS), and is configured to obtain the position information of the moving vehicle 150.

The storage unit 157 is, e.g., any type of fixed or portable random access memory (RAM), read-only memory (ROM), flash memory, or a similar element or a combination of the above elements. The storage unit 157 is configured to store various internal information (e.g., motion information, position information and mechanical control information, etc.) and external information (external images, audio signals and external transmission information, etc.) obtained by the moving vehicle 150.

The processing unit 158 is coupled to the machine element 151, the transducer 152, the communication module 153, the image capturing apparatus 154, the recording apparatus 155, the positioning apparatus 156 and the storage unit 157. The processing unit 158 may be a central processing unit (CPU), a microprocessor, a digital signal processor (DSP), a programmable controller, an application specific integrated circuit (ASIC), a system on chip (SoC), or other similar element or a combination of the above elements. In the embodiments of the invention, the processing unit 158 is configured to perform all the operations of the moving vehicle 150.

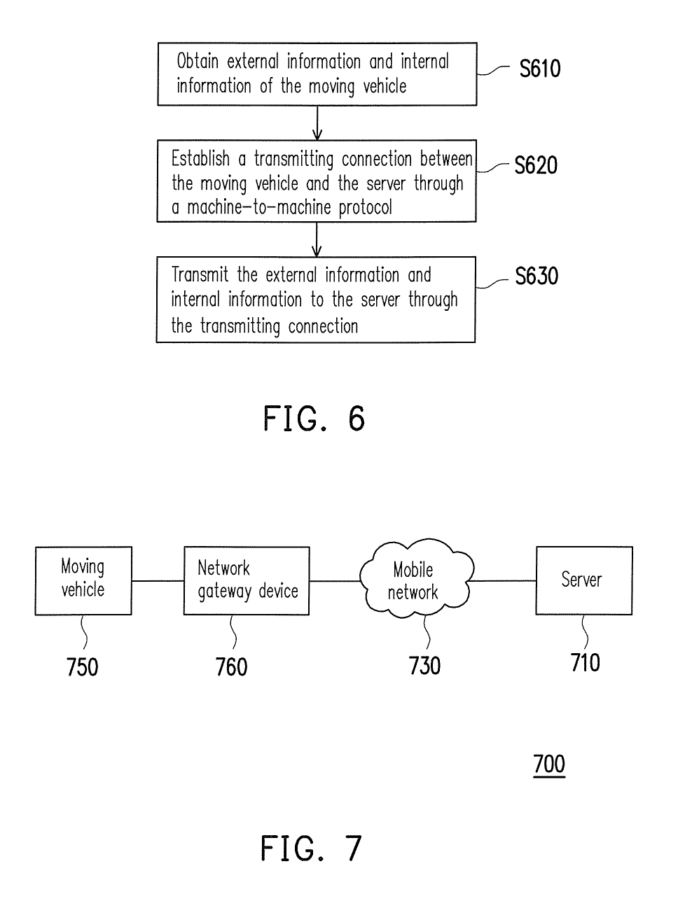

To facilitate understanding of the operation processes in the embodiments of the invention, an information backing up method of the information backing up system 100 will be hereinafter explained in detail with reference to numerous examples. FIG. 6 is a flow chart illustrating an information backing up method according to an embodiment of the invention. Referring to FIG. 6, the method in the present embodiment is applicable to the information backing up system 100 in FIG. 1 and the moving vehicle 150 in FIG. 2. In the following, the method in the present embodiment will be described with reference to the apparatuses, elements and modules in the information backing up system 100 and the moving vehicle 150. The steps in this method may be varied according to actual situations and are not limited to those described herein.

In step S610, the processing unit 158 of the moving vehicle 150 obtains the external information and the internal information of the moving vehicle 150. In an embodiment, the internal information includes motion information, position information and mechanical control information. The processing unit 158 of the moving vehicle 150 obtains the motion information through the transducer 152, obtains the position information of the moving vehicle 150 through a positioning system (e.g., GPS, GLONASS, etc.) installed in the positioning apparatus 156, and obtains the mechanical control information (e.g., voltage information, control mode, throttle pedal information, analog voltage, pulse width modulation (PWM), etc.) of the machine element 151 in the moving vehicle 150.

In another embodiment, the external information includes an external image, an audio signal and external transmission information. The processing unit 158 of the moving vehicle 150 obtains the external image through the image capturing apparatus 154, records the audio signal through the recording apparatus 155, and receives the external transmission information (e.g., human body status, human motion information, etc.) from a wearable apparatus (not illustrated; e.g., a smart watch, smart glasses, a human body sensor, etc.) through the communication module 153.

In step S620, the communication module 153 of the moving vehicle 150 establishes a transmitting connection with the server 110 through a machine-to-machine (M2M) (or machine-type communication (MTC)) protocol. In the present embodiment, the communication module 153 of the moving vehicle 150 connects to the server 110 via the mobile network 130, and performs an M2M handshaking procedure with the server 110 based on the M2M protocol through the mobile network 130. Specifically, in the embodiments of the invention, the information backing up system 100 is constructed based on an M2M network. That is, the moving vehicle 150 and the server 110 are devices having M2M functions. The M2M protocol architecture is divided into a sensing layer, a network layer and an application layer, and operates in the following manner. A sensing-related element or apparatus such as the transducer 152, the image capturing apparatus 154 or the recording apparatus 155 captures information, the information is then transmitted using wireless network techniques such as GPRS, 3G, 4G or wireless local area network (WLAN), and a connection is established with a cloud service of the server 110 through the application layer.

It is to be noted that, when the moving vehicle 150 establishes a connection via the mobile network 130, registration and authorization procedures are performed with a telecommunications operator that provides services of the mobile network 130, so as to confirm the M2M functions supported by the moving vehicle 150 and to ensure security of the information. In addition, by the M2M handshaking procedure, it is confirmed that a transmission channel has been established between the moving vehicle 150 and the server 110.

In step S630, the processing unit 158 of the moving vehicle 150 transmits the external information and the internal information to the server 110 through the transmitting connection by means of the communication module 153. Specifically, after it is confirmed that the transmission channel has been established, the processing unit 158 of the moving vehicle 150 backs up the obtained external information and internal information onto the server 110 through the communication module 153 based on a backup mechanism. This backup mechanism may include time scheduling (e.g., transmission in intervals of 10 or 20 minutes), triggering conditions (e.g., receipt of an error message, a failure in the machine element 151, a temperature being higher than a specific threshold value, a warning event, etc.), and external command settings, and may be modified by anyone who uses the embodiments of the invention depending on different design requirements.

In an embodiment, after receiving the internal information and the external information transmitted by the moving vehicle 150, the server 110 analyses the external information and the internal information, so as to perform a dispatching management operation, a mobile management operation, and a resource management operation, etc. For example, in the dispatching management operation, the server 110 transmits a dispatching instruction to the moving vehicle 150 through the transmission channel, and a driver of the moving vehicle 150 checks the dispatching instruction. In the mobile management operation, the server 110 displays positions of one or a plurality of moving vehicles 150 on an HMI through an electronic map. In the resource management operation, the server 110 assigns work to a plurality of moving vehicles 150 based on the logistics. In addition, the server 110 also analyses the mechanical control information so as to determine whether a failure has occurred in the moving vehicle 150.

It is to be noted that, depending on different design requirements and M2M service contents, management operations (e.g., real-time communication, transaction management, remote control, address search, provision of road conditions, etc.) that can be performed by the server 110 may vary.

In the aforementioned embodiments, the moving vehicle 150 is connected to the server 110 to perform backup operations directly via the mobile network 130. In another embodiment, the moving vehicle may perform uploading through other devices, and thus, a problem that some moving vehicles do not support mobile network can be solved.

FIG. 7 is a schematic block diagram illustrating an information backing up system according to another embodiment of the invention. Referring to FIG. 7, an information backing up system 700 includes a server 710, a moving vehicle 750 and a network gateway device 760. It is to be noted that, in actual application, the information backing up system 700 may include more than one server 710, more than one moving vehicle 750 and more than one network gateway device 760.

The server 710 and the moving vehicle 750 have the same or similar elements as the server 110 and the moving vehicle 150 in FIG. 1, and thus detailed descriptions thereof are omitted herein. FIG. 7 differs from FIG. 1 in that the network gateway device 760 (e.g., a smartphone, a tablet PC, a notebook computer, an M2M gateway device, a routing device, etc.) is capable of connecting to the mobile network 730, and that the moving vehicle 750 establishes a transmitting connection with the server 710 via the network gateway device 760 through an M2M protocol. In other words, the network gateway device 760 serves as a medium for transmitting information for the moving vehicle 750 to the server 710. The moving vehicle 750 automatically pushes internal information and external information to the network gateway device 760 (using transmission techniques such as WiFi or Bluetooth, etc.), or the network gateway device 760 generates an information obtaining request so as to obtain internal information and external information from the moving vehicle 750.

Therefore, if the moving vehicle 150 or 750 backs up internal information and external information at fixed intervals, when an event or problem occurs, an administrator on the side of the server 110 or 710 instantly determines relevant information such as the current position of the moving vehicle 150 or 750 or the failure based on the uploaded internal information and external information, and performs corresponding rescue operations.

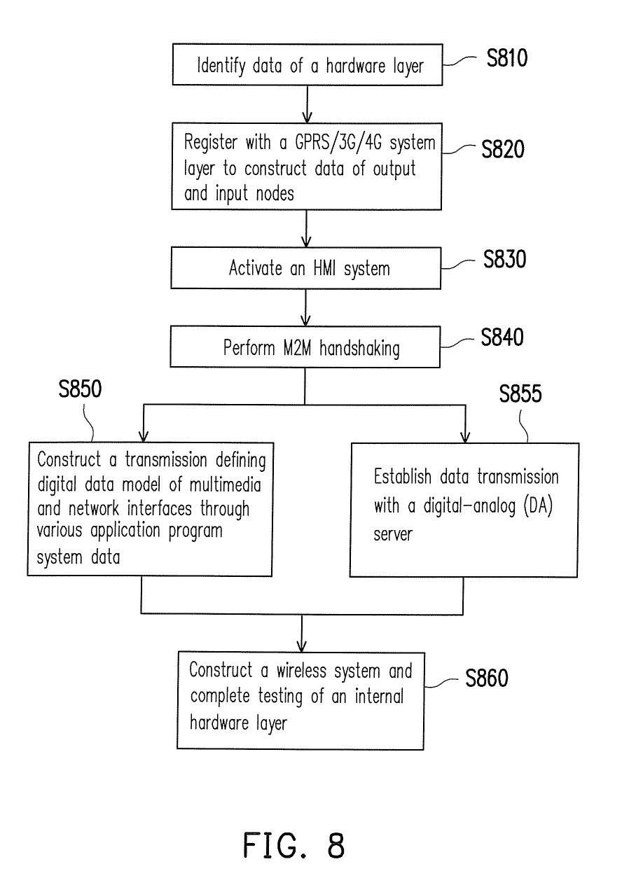

FIG. 8 illustrates an example of a process of backing up information according to an embodiment of the invention. Referring to FIG. 8, the method of the present embodiment is applicable to both the information backing up systems 100 and 700. To facilitate the illustration, the method of the present embodiment is described with reference to the apparatuses in the information backing up system 100. The steps in this method may be varied according to actual situations and are not limited to those described herein.

The moving vehicle 150 performs data identification with respect to a hardware layer (e.g., the machine element 151, the transducer 152, the image capturing apparatus 154, the recording apparatus 155, and the positioning apparatus 156) and selects a registered system (step S810). For example, information to be backed up is determined based on a backup mechanism. The moving vehicle 150 registers with a GPRS/3G/4G system layer of a telecommunications operator so as to construct data of output and input nodes (step S820). Next, an HMI system of the moving vehicle 150 is activated (step S830), and an M2M handshaking procedure is performed so as to establish an M2M transmission channel (step S840). The moving vehicle 150 constructs a transmission defining digital data model of multimedia and network interfaces through various application program system data (step S850). On the other hand, the moving vehicle 150 also establishes data transmission with a digital-analog (DA) server (e.g., the server 110) (step S855), so as to upload mechanical control information or sensing information such as analog voltage, PWM analog information, temperature information, etc. When a wireless system is constructed (i.e., when transmitting communication is established), the moving vehicle 150 performs checking and testing procedures such as the voltage and auxiliary check 321 and the analog/digital signal check 322 as shown in FIG. 3 (step S860).

In summary, the information backing up system and method proposed by the embodiments of the invention operate as follows. Based on a machine-to-machine (M2M) protocol, various internal information and external information obtained by a moving vehicle are backed up onto a server that provides cloud services, thereby enabling the server to easily perform remote monitoring and management. In addition, the moving vehicle may also upload information to the server through a network getaway device, thus providing another transmission path. Since the moving vehicle transmits all the records to the server through the cloud services for backup during its travel, even if the moving vehicle is damaged or explodes into pieces, the information on the moving vehicle has already been transmitted to a remote end. Accordingly, the embodiments of the invention eliminate the existing fear that the cause of an aircraft incident cannot be identified in cases the black box is lost.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. An information backing up method applicable to a moving vehicle and a server, comprising:
obtaining external information and internal information of the moving vehicle;
establishing a transmitting connection between the moving vehicle and the server through a machine-to-machine (M2M) protocol; and
transmitting the external information and the internal information to the server through the transmitting connection.

2. The information backing up method according to claim 1, wherein the step of establishing the transmitting connection between the moving vehicle and the server through the M2M protocol comprises:
connecting to the server via a mobile network; and
performing an M2M handshaking procedure with the server based on the M2M protocol through the mobile network.

3. The information backing up method according to claim 1, wherein the external information comprises an external image, an audio signal and external transmission information, and the step of obtaining the external information and the internal information of the moving vehicle comprises:
obtaining the external image through an image capturing apparatus;
recording the audio signal through a recording apparatus; and
receiving the external transmission information from a wearable apparatus.

4. The information backing up method according to claim 1, wherein the internal information comprises motion information, position information and mechanical control information, and the step of obtaining the external information and the internal information of the moving vehicle comprises:
obtaining the motion information through at least one transducer;
obtaining the position information of the moving vehicle through a positioning system; and
obtaining the mechanical control information of a plurality of machine elements in the moving vehicle.

5. The information backing up method according to claim 1, wherein after transmitting the external information and the internal information to the server through the transmitting connection, further comprising,:
analyzing the external information and the internal information through the server, so as to perform a dispatching management operation, a mobile management operation, and a resource management operation.

6. An information backing up system, comprising:
a server; and
a moving vehicle, obtaining external information and internal information of the moving vehicle, establishing a transmitting connection with the server through an M2M protocol, and transmitting the external information and the internal information to the server through the transmitting connection.

7. The information backing up system according to claim 6, wherein the moving vehicle connects to the server via a mobile network, and performs an M2M handshaking procedure with the server based on the M2M protocol through the mobile network.

8. The information backing up system according to claim 6, wherein the external information comprises an external image, an audio signal and external transmission information, and the moving vehicle obtains the external image through an image capturing apparatus, records the audio signal through a recording apparatus, and receives the external transmission information from a wearable apparatus.

9. The information backing up system according to claim 6, wherein the internal information comprises motion information, position information and mechanical control information, and the moving vehicle obtains the motion information through at least one transducer, obtains the position information of the moving vehicle through a positioning system, and obtains the mechanical control information of a plurality of machine elements in the moving vehicle.

10. The information backing up system according to claim 6, wherein the server analyzes the external information and the internal information, so as to perform a dispatching management operation, a mobile management operation, and a resource management operation.

11. An information backing up system, comprising:
a server;
a network gateway device; and
a moving vehicle, obtaining external information and internal information of the moving vehicle, establishing a transmitting connection with the server via the network gateway device through an M2M protocol, and transmitting the external information and the internal information to the server through the transmitting connection.
